(19) United States
(12) Patent Application Publication
(10) Pub. No.: US 2011/0076865 A1
(43) Pub. Date: Mar. 31, 2011

(54) ELELCTRICAL CONNECTOR HAVING TERMINALS WITH DIFFERENT TYPES OF TAILS

(75) Inventors: YU LUO, Shenzhen (CN); BO YAN, Shenzhen (CN)

(73) Assignee: HON HAI PRECISION INDUSTRY CO., LTD., Tu-Cheng (TW)

(21) Appl. No.: 12/890,716

(22) Filed: Sep. 27, 2010

(30) Foreign Application Priority Data
Sep. 29, 2009 (CN) 200920311819.4

(51) Int. Cl. H01R 12/70; H01R 24/00

(52) U.S. Cl. 439/82; 439/660

(57) ABSTRACT

An electrical connector includes an insulative housing and a plurality of terminals secured in the housing. The insulative housing includes a mating face, an mounting face opposite to the mating face and a receiving slot penetrating through the mating face. The receiving slot has opposite first and second sidewalls. The first sidewall defines spaced first and second mating portions, the second sidewall defines a third mating portion. The terminals include first terminals and second terminals of different types. The first and second mating portions are loaded with the first terminals, and the third mating portion are loaded with the second terminals.

### BACKGROUND OF THE INVENTION

1. Field of the Invention

The present invention relates to an electrical connector, and more particularly to an electrical connector having terminals with different types of tails.

2. Description of the Related Art

An electrical connector mounted on a printed circuit board comprises an insulative housing and a plurality of terminals secured in the housing. Conventionally, the terminals are electrically connected to the printed circuit board by soldering. In recent years, connectors with press-fit terminals have come to be used. U.S. Pat. No. 7,481,657 issued to Kiat et al. discloses a SAS (Serial Attached SCSI) receptacle comprising an insulative housing and a plurality of terminals secured in the housing. The housing defines a receiving slot and opposite first and second walls located two sides of the slot. First and second rows of terminals are retained in the first wall of the housing and a recess is formed between the first and second rows of terminals. A third row of terminals is retained in the second wall of the housing and corresponds to the recess. The pitch of the adjacent terminals of the third row is smaller than that of the adjacent terminals of the first or second rows. Furthermore, the dimension of each terminal of the third row is smaller than that of each terminal of the first and second rows. Therefore, it is difficult to produce the terminals of the third row which have press-fit tails thereof

In view of the above, a new electrical connector that overcomes the above-mentioned disadvantages is desired.

### SUMMARY OF THE INVENTION

Accordingly, an object of the present invention is to provide an electrical connector having improved terminals.

To fulfill the above-mentioned object, an electrical connector comprises an insulative housing and a plurality of terminals secured in the housing. The insulative housing comprises a mating face, an mounting face opposite to the mating face and a receiving slot penetrating through the mating face. The receiving slot has opposite first and second sidewalls. The first sidewall defines spaced first and second mating portions, the second sidewall defines a third mating portion. The terminals comprise first terminals and second terminals of different types. The first and second mating portions are loaded with the first terminals, and the third mating portion are loaded with the second terminals.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an electrical connector mounted on a PCB in accordance with the present invention;

FIG. 2 is a perspective view of the electrical connector and the PCB;

FIG. 3 is an exploded, perspective view of the electrical connector of the FIG. 1; and

FIG. 4 is a perspective view of the electrical connector of FIG. 1.

### DETAILED DESCRIPTION OF THE PREFERRED EMBODIMENT OF THE INVENTION

The present invention will now be described in detail with reference to a preferred embodiment thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps have not been described in detail in order to not unnecessarily obscure the present invention.

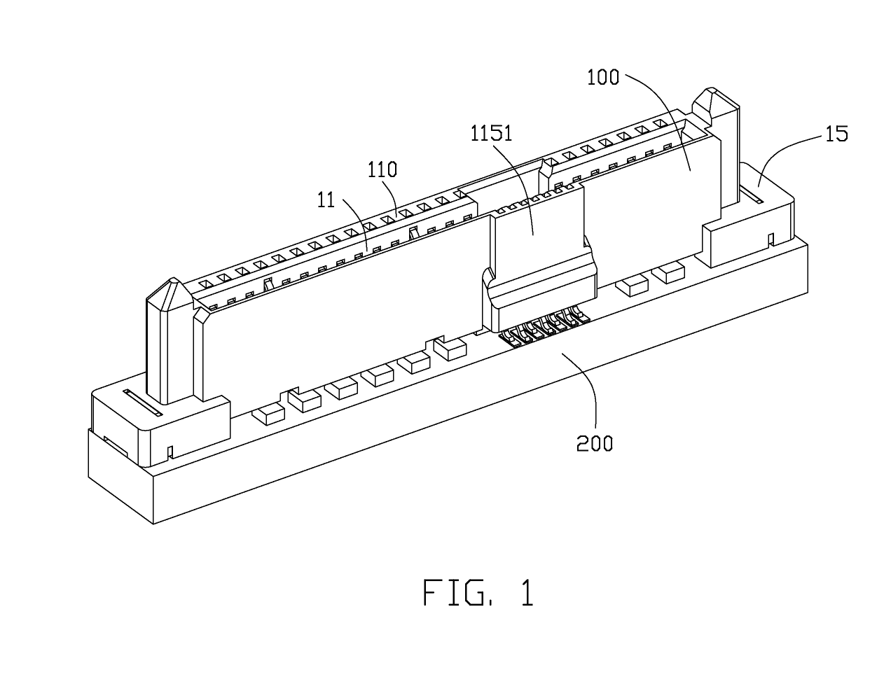

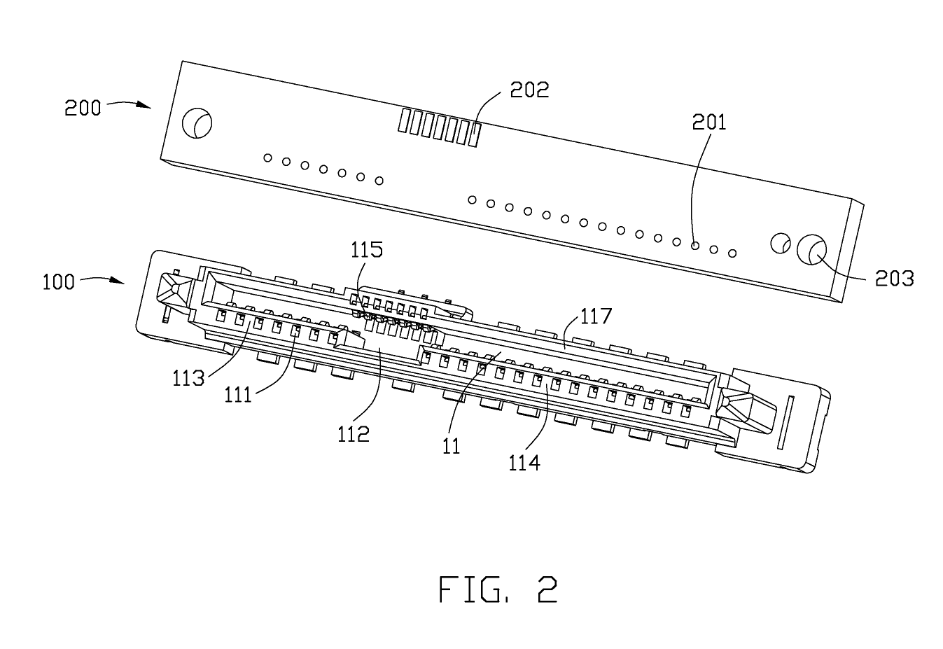

Referring to FIGS. 1 to 2, an electrical connector assembly comprises a PCB (Printed Circuit Board) 200 and an electrical connector 100 mounted on the PCB 200. The PCB 200 has two spaced groups of through holes 201 extending in one row and a group of conductive pads 202 located thereon in one row.

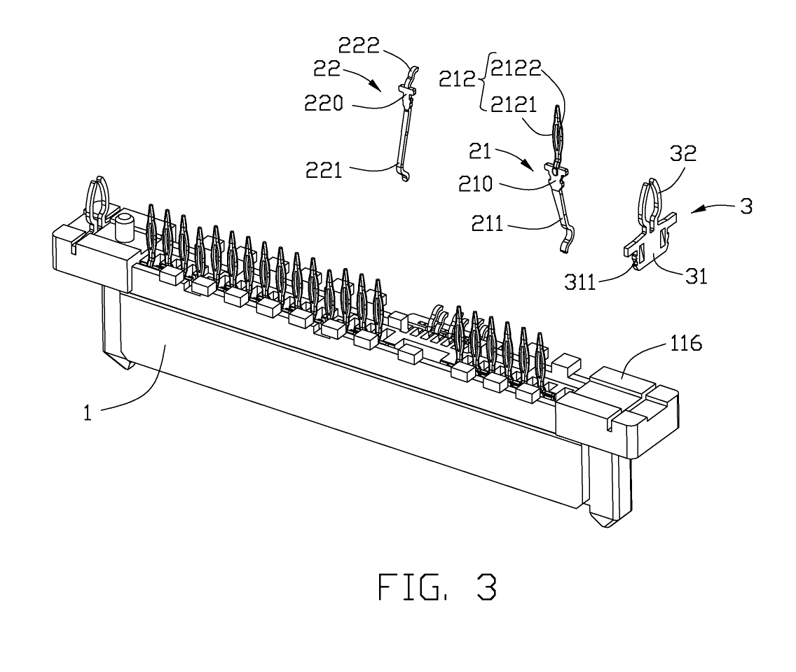

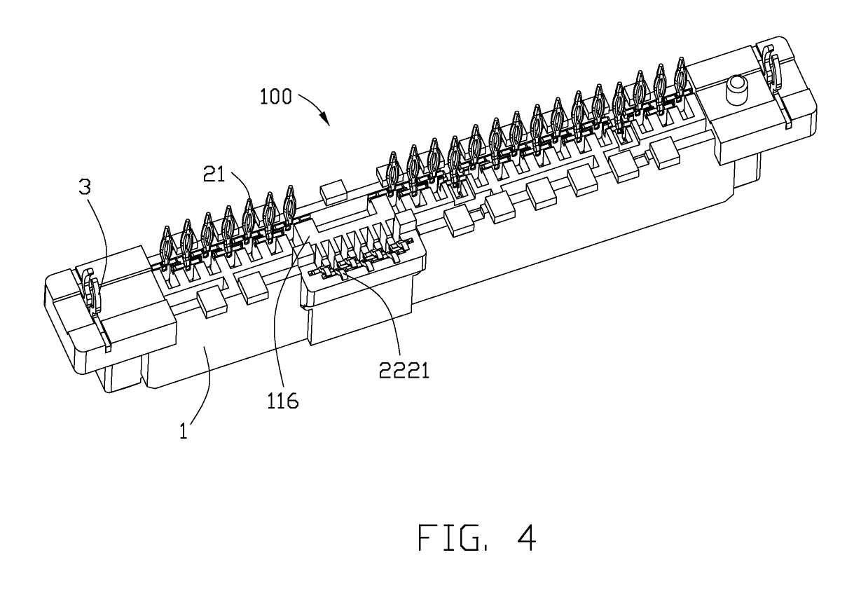

Referring to FIGS. 1 to 4, the electrical connector 100 comprises an insulative housing 1 and a plurality of terminals secured in the housing 1. The insulative housing 1 comprises a mating face 110, an opposite mounting face 116 and a receiving slot 11 penetrating through the mating face 110. The receiving slot 11 has a first sidewall 111 and a second sidewall 117 opposite to the first sidewall 111. The first sidewall 111 defines a first mating portion 113 and a second mating portion 114 spaced from the first mating portion 113 by a recess 112 formed in the first sidewall 111 and located between the first mating portion 113 and the second mating portion 114. The second sidewall 117 defines an expanding portion 1151 thicker than other portion of the second sidewalls to form a third mating portion 115 corresponding to and aligned with the recess 112. A plurality of passageways (not labeled) are formed in the first, second and third mating portion to receive the terminals. The terminals comprising some first terminals 21 and some second terminals 22.

The first terminals 21 are secured in the first mating portion 113 and the second mating portion 114, and the second terminals 22 are secured in the third mating portion 115. The first terminal 21 is punched out of a metal sheet and comprises a retention portion 210 secured in the housing 1, a contact portion 211 extending from one end of the retention portion 210 and a press-fit tail 212 extending from the other end of the retention portion 210. The contact portions 211 extend into the receiving slot 11 so as to engage with corresponding mating terminals (not shown). The press-fit tail 212 is configured by shuttle portions 2121 with an elliptical slit 2122 disposed at a center portion of the shuttle portion. The elliptical slit extends along a same extending direction of the shuttle portion. The press-fit tails 212 of the first terminals are pressed into the corresponding through holes 201 of the PCB 200 respectively. The shuttle portions 2121 are compressed and deformed so that the reaction force causes the shuttle portions 2121 to press against inner walls of the through holes 201 and produce a secure electrical connection.

The second terminal 22 comprise a retention portion 220 secured in the housing 1, a contact portion 221 extending from one end of the retention portion 220 and a pressed tail 222 extending from the other end of the retention portion 220. The contact portions 221 extend into the receiving slot 11 so as to engage with corresponding mating terminals. The pressed tail 222 obliquely extends toward the second sidewall 117 and forms a curved point 2221. The curved point 2221 of the pressed tail 222 extends beyond and face to the mounting face 116 of the insulative housing so as to abut against the conductive pads 202 of the PCB 200. Therefore, a reliable electrical connection is formed.

Two mounting portions 15 extend outwardly from two ends of the insulative housing 1. A pair of board locks 3 is secured in the mounting portions 15 of the insulative housing 1 respectively. Each board lock 3 comprises a base portion 31 with barbs 311 and a pair of locking legs 32 extending downwardly beyond the mounting face 116 of the insulative housing 1.

In assembly, firstly the first terminals 21 and the second terminals 22 are mounted to the insulative housing 1 from the mounting face 116, and the board locks 3 are also mounted to the two ends of the insulative housing 1 from the mounting face 116. Secondly, the electrical connector 100 is assembled to the PCB 200, the press-fit tails 212 of the first terminals 21 are inserted into the through holes 201 of the PCB 200, and the pressed tails 222 of the second terminals 22 resiliently abut against conductive pads 202 of the PCB 200. In the meantime, the locking legs 32 of the board locks 3 are inserted into position holes 203 of the PCB 200 so that the connector 100 is securely attached to the PCB. To ensure a fitly connection with the PCB, the tails are soldered to the PCB finally.

The first terminals 21 are wider than the second terminals 22 and has a larger pitch between every adjacent first terminals than that of the second terminals. Thus, the pressed tails of the second terminals benefit usage of the terminals

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector comprising:
an insulative housing comprising a mating face, an mounting face opposite to the mating face and a receiving slot penetrating through the mating face, the receiving slot having opposite first and second sidewalls, the first sidewall defining spaced first and second mating portions, the second sidewall defining a third mating portion;
a plurality of terminals secured in the housing and comprising first terminals and second terminals of different types;
wherein the first and second mating portions are loaded with the first terminals, and the third mating portion are loaded with the second terminals.

2. The electrical connector as claimed in claim 1, wherein each first terminal comprises a first retention portion, a first contact portion extending into the receiving slot and a shuttle tail extending beyond the mounting face, the shuttle tail has an elliptical slit formed therein.

3. The electrical connector as claimed in claim 2, wherein each second terminal comprises a second retention portion, a second contact portion extending into the receiving slot and a pressed tail obliquely extending beyond the mounting face with a contacting point opposite to the mounting face.

4. The electrical connector as claimed in claim 3, wherein a recess is formed in the first sidewall and located between the first mating portion and the second mating portion, the third mating portion corresponds to the recess.

5. The electrical connector as claimed in claim 4, wherein a pair of board locks is secured at two ends of the insulative housing respectively, each board lock comprises a base portion and a pair of locking legs extending downwardly beyond the mounting face of the housing.

6. An electrical connector assembly, comprising:
a PCB (Printed Circuit Board) having a row of through holes thereof and a row of conductive pads thereon parallel to said row of the through holes;
an insulative housing comprising a mating face, an mounting face confronting with the PCB and a receiving slot penetrating through the mating face;
a plurality of terminals secured in the housing and comprising contact portions exposing to the receiving slot and tails connecting with the through holes and the conductive pads, the plurality of terminals divided to first contacts connecting with the through hole and second terminals connecting with the conducive pads;
wherein the tails of the first terminals are of an shuttle shape with a central slit to be inserted in the through holes and the tail of the second terminals are pressed against the conductive pads in a direction perpendicular to the PCB.

7. The electrical connector assembly as claimed in claim 6, wherein the first terminals are larger than the second terminals in width.

8. The electrical connector assembly as claimed in claim 7, wherein the first terminals have a large pitch between every adjacent first terminals than that of the second terminals.

9. The electrical connector assembly as claimed in claim 6, wherein a recess is formed in the first sidewall and located between the first mating portion and the second mating portion, the third mating portion corresponds to the recess.

10. The electrical connector assembly as claimed in claim 7, wherein a pair of board locks is secured at two ends of the insulative housing respectively, each board lock comprises a base portion and a pair of locking legs extending downwardly beyond the mounting face of the housing.

11. An electrical connector for mounting to a printed circuit board, comprising:
an elongated insulative housing defining a central slot along a lengthwise direction thereof between opposite first and second longitudinal side walls which are spaced from each other in a lateral direction perpendicular to said lengthwise direction;
a first sets of contacts disposed in the first longitudinal side wall;
a second set of contacts disposed in the second longitudinal side wall under condition that said second set of contacts is offset from the first set of contacts in the lengthwise direction; and
each of said first set and second set of contacts defining a resilient contacting section extending into the central slot, and a tail section exposed outside of the housing; wherein
the tail sections of the first set of contacts are of a press-fit type adapted to be inserted into corresponding through holes in the printed circuit board while the tail sections of the second set of contacts are of a compression type which are adapted to press against a mounting surface of the printed circuit board on which the housing is mounted.

12. The electrical connector as claimed in claim 11, wherein said first set of contacts are arranged in two groups, and said second set of contacts is located between said two group in said lengthwise direction so as to assure a balanced arrangement of a press-fit retention by two sides of a compression engagement.

13. The electrical connector as claimed in clam 12, wherein some of the tail sections of the first set of contacts are offset from the remaining of those of the first set of contacts in a vertical direction perpendicular to both said lengthwise direction and said lateral direction for dispersing assembling forces, while some of the tail sections of the second set of contacts are offset from the remaining of those of the second set of contacts in the lateral direction for dispersing retention forces.

14. The electrical connector as claimed in claim 11, further including a pair of board locks at two opposite ends of the housing in said lengthwise direction.

15. The electrical connector as claimed in claim 14, wherein said press-fit type tail sections of the first set of contacts exert forces in the lengthwise direction while said board locks exert forces in the lateral direction.

16. The electrical connector as claimed in claim 14, wherein a mounting post extends downwardly from the housing beside one of said board locks in the lengthwise direction.
